(19) United States
(12) Patent Application Publication
(10) Pub. No.: US 2006/0080626 A1
(43) Pub. Date: Apr. 13, 2006

(54) Visualization method and apparatus for logic verification and behavioral analysis

(75) Inventors: Nobuyuki Ohba, Miyagi-ken (JP); Kohji Takano, Tokyo-to (JP)

Correspondence Address: IBM MICROELECTRONICS;INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, NY (US)

(21) Appl. No.: 11/163,292

(22) Filed: Oct. 13, 2005

(30) Foreign Application Priority Data
Oct. 13, 2004 (JP) 2004-298264

(51) Int. Cl. G06F 17/50; G06F 11/00; G06F 9/45

(52) U.S. Cl. 716/6; 714/37; 703/16

(57) ABSTRACT

A logic verification tool detects and flags a logic operation with high probability to cause a fault in an electronic system. An efficient logic debug method utilizes a partial sequence of signal outputs and state transitions to extrapolate a verification result with equivalent robustness to full regression testing.

### FIELD OF THE INVENTION

The present invention relates to an observation device, an observation method for logic verification and behavioral analysis. The present invention relates particularly to an observation device, an observation method and a program thereof for receiving a signal which is outputted by a logic unit to be observed, and for observing an operation of the logic unit to be observed.

### BACKGROUND OF THE INVENTION

Techniques for assisting the debugging of a designed logic circuit have been previously disclosed by the following patent literature. United States Patent No. 5,576,979 discloses a method of generating a timing diagram for an electronic circuit under test. A technique disclosed by U.S. Pat. No. 6,289,489 makes it possible to cause a hardware description language (HDL) and a state of a logic circuit, which is displayed by a graphical user interface (GUI), to correspond to each other, thereby enabling a cross reference to be made between the hardware description language and the state of the logic circuit. A method disclosed by U.S. Pat. No. 5,920,711 generates a hardware description of a logic circuit which implements a communication protocol designated by a user. A technique disclosed by U.S. Pat. No. 6,553,514 performs a formal verification based on the results of a software simulation. A technique disclosed by U.S. Pat. No. 6,751,582 provides a GUI which enables the formal verification to be performed efficiently. A technique disclosed by U.S. Pat. No. 6,647,513 efficiently provides a test case for logic function verification, and displays coverage of verification items.

Software simulation and hardware testing are known verification techniques for logic circuit design.

Verification by software simulation can be started relatively quickly after description of the logic circuit is completed, and according to the verification, operations of all the signals in the logic circuit can be recorded and observed. However, a large-scale simulation requires a significant amount of processing time. Consequently, software simulation is used at an initial stage of the debugging of the logic circuit for operating the logic circuit within a range of a relatively small number of clock cycles. In this way, initial failures may be identified by operating the logic circuit on a modular basis to facilitate debugging each element of the design. The operation of each verified logic element becomes gradually stable through the software simulation debug process.

In contrast, verification with actual hardware can be performed at high speed by using a device such as a field programmable gate array (FPGA) capable of programming the logic circuit to be verified or using a prototype of the actual device. Therefore, hardware verification is performed in order to find failures occurring in the case of interconnecting circuit components. Such failures result from the presence of an item missing from verification items for each component or logic function, a factor such that specifications are inaccurate or misunderstood, an unexpected operation caused by a combination of the component parts, etc.

For hardware based logic verification, the number of parts is so large that the operation must be performed at high speed. Accordingly, for example, it is common to capture and analyze, as time series data, partially observable signals such as interface signals between logic components using an oscilloscope or logic analyzer. However, as verification process using hardware progresses, the frequency of failure occurrences tends to decreases to, for example, once per several days, and it becomes difficult to specify in advance the timing at which failures will occur. When the time series data of all the signals is recorded in order to appropriately observe failures as described above, the amount of data becomes too large for practical analysis.

### SUMMARY OF THE INVENTION

In this regard, it is an object of the present invention to provide an observation device, an observation method, and a program product in a logic verification environment, which are capable of solving the above-described problems. This object is attained by a combination of features described in independent claims in the scope of claims, and dependent claims advantageously define more specific examples of the present invention.

A first aspect of the present invention provides an observation device for receiving a signal which is outputted by a unit to be observed, and for observing an operation of the unit to be observed, comprising: an output signal acquiring unit for acquiring an output signal which is outputted by the unit to be observed; a state transition storing unit for storing a set, which consists of parts of an output signal which correspond respectively to a series of two or more cycles, as a state transition of the output signal, if the output signal is acquired through the series of two and more cycles; a state transition adding unit for causing the state transition storing unit to additionally store a set, which consists of parts of an output signal corresponding respectively to a series of two or more cycles of the output signal which has been newly acquired by the output signal acquiring unit, as a new state transition, in a case where a state transition corresponding to the set concerning the newly acquired output signal has not been stored in the state transition storing unit; and a state transition outputting unit for outputting a state transition of output signals which have been stored in the state transition storing unit. Moreover, this aspect of the present invention provides an observation method and a program, which relate to the observation device.

Note that the above-described summary of the invention does not list all features necessary for the present invention, and subcombinations of groups of these features can also be incorporated in the invention.

According to the present invention, an operation which is highly likely to cause a fault can be detected and noticed, thereby enabling a logic circuit to be debugged efficiently.

### BRIEF DESCRIPTION OF THE DRAWINGS

For a more complete understanding of the present invention and the advantages thereof, reference is now made to the following description taken in conjunction with the accompanying drawings.

FIG. 1 shows a configuration of an observation device according to an embodiment of the present invention.

FIG. 2 shows the operation of the observation device according to the embodiment of the present invention.

FIG. 3 shows an example of a display of a tabular format by the observation device according to the embodiment of the present invention.

FIG. 4 shows an example of a timing chart in tabular format generated by the observation device according to the embodiment of the present invention.

FIG. 5 shows an example of a reduced display of a state transition diagram by the observation device according to the embodiment of the present invention.

FIG. 6 shows an example of an expanded display of the state transition diagram by the observation device according to the embodiment of the present invention.

FIG. 7 shows an example of comparison displays of the state transitions by the observation device according to the embodiment of the present invention.

FIG. 8 shows an example of a selection display of the state transition by the observation device according to the embodiment of the present invention.

FIG. 9 shows an example of a display of timing charts by the observation device according to the embodiment of the present invention.

FIG. 10 shows an example of display of a histogram by the observation device according to the embodiment of the present invention.

FIG. 11 shows an example of a hardware configuration of a computer according to the embodiment of the present invention.

### DETAILED DESCRIPTION OF THE PREFERRED EMBODIMENT

While the invention will be described below with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

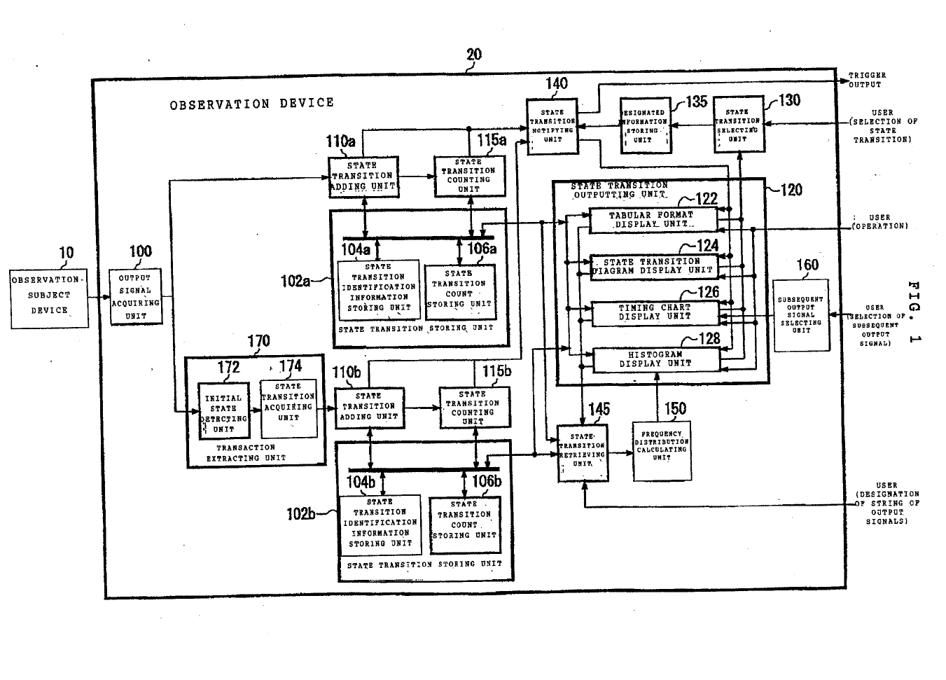

FIG. 1 shows a configuration of an observation device 20 according to a preferred embodiment together with an observation-subject device 10. The observation-subject device 10 is a logic device to be observed, for example, a hardware emulator composed of an FPGA in which a logic circuit to be verified is programmed, a device including one or more large scale integrated circuits (LSI) implemented with the logic circuit to be verified. Moreover, the observation-subject device 10 may be an information processing apparatus that executes software such as a logic circuit simulator, thereby simulating the logic circuit to be verified.

The observation device 20 receives a signal outputted from the observation-subject device 10, and observes an operation of the observation-subject device 10. Then, the observation device 20 detects an operation having a high probability to cause a failure, and makes a notification thereof to a user of the observation device 20 and another observation device such as a logic analyzer connected to the observation-subject device 10 and the observation device 20. Here, the signal outputted from the observation-subject device 10 to the observation device 20 may be an interface signal between parts in the observation-subject device 10, a signal extracted from the logic circuit in the observation-subject device 10 for the purpose of observation, or an output interface signal or control signal of the observation-subject device 10.

The observation device 20 includes an output signal acquiring unit 100, state transition storing units 102a and 102b, state transition adding units 110a and 110b, state transition counting units 115a and 115b, a transaction extracting unit 170, a state transition outputting unit 120, a state transition selecting unit 130, a designated information storing unit 135, a state transition notifying unit 140, a state transition retrieving unit 145, a frequency distribution calculating unit 150, and a subsequent output signal selecting unit 160.

The output signal acquiring unit 100 acquires an output signal outputted by the observation-subject device 10 for each cycle on the observation device 20. Here, data of the output signal may be a fixed- or variable-length bit string transmitted on a signal line from the observation-subject device 10 to the observation device 20 over one or more cycles in the signal line of interest. Specifically, for example, when the output signal is an 8-bit signal, transmitted over a serial interface, an output signal for one cycle on the observation device 10 is transmitted over eight cycles in the signal line of interest.

The state transition storing unit 102a stores, as a state transition of the output signal, a set of output signals acquired in two or more continuous cycles. In this embodiment, the state transition storing unit 102a stores, as the state transition of the output signal, a set of output signals acquired in two continuous cycles. For example, when data A is acquired as an output signal in a certain cycle, and data B is acquired as an output signal in the next cycle, the state transition storing unit 102a stores a set of the output signals (A, B) as a state transition from the data A to the data B. In another aspect, the state transition storing unit 102a may use a set of output signals acquired over more fixed or variable cycles.

The state transition storing unit 102a includes a state transition identification information storing unit 104a, and a state transition count storing unit 106a. The state transition identification information storing unit 104a stores a set of the output signals and state transition identification information for identifying a state transition corresponding to the set of output signals in association with each other. The state transition identification information storing unit 104a is, for example, a memory receiving the state transition identification information as an address, and may store each state transition in an address designated by state transition identification information assigned to the state transition concerned.

The state transition count storing unit 106a stores the state transition identification information stored in the state transition identification information storing unit 104a and the number of occurrences (a count of occurrences) of the state transition identified by the state transition identification information concerned in association with each other. The state transition count storing unit 106a is, for example, a memory receiving the state transition identification information as an address, and may store the number of occurrences of each state transition in an address designated by state transition identification information assigned to the state transition concerned.

When a state transition corresponding to a set of output signals newly acquired by the output signal acquiring unit 100 is not stored in the state transition storing unit 102a, the state transition adding unit 110a adds the set of newly acquired output signals as a new state transition to the state transition storing unit 102a, and stores the set concerned therein. When the state transition corresponding to the set of output signals newly acquired by the output signal acquiring unit 100 is stored in the state transition storing unit 102a, the state transition counting unit 115a increments the number of occurrences of each state transition of the output signal, which is stored in the state transition storing unit 102a correspondingly to the state transition concerned.

From time series data of the output signals acquired by the output signal acquiring unit 100, the transaction extracting unit 170 extracts a transaction as one or a set of plural output signals transmitting a sequence of information. More specifically, when the observation-subject device 10 does not output effective data to the signal line to the observation device 20, the observation-subject device 10 is assumed to be at an initial state where the output signals are not used for transmitting the information. The transaction extracting unit 170 extracts, as the transaction, a set of output signals of a period while the signal line is shifting from the initial state, transferring a series of effective data, and returning to the initial state again.

The transaction extracting unit 170 includes an initial state detecting unit 172, and a state transition acquiring unit 174. When output signals acquired by the output signal acquiring unit 100 meet predetermined conditions of the initial state, the initial state detecting unit 172 detects that the output signals are in the initial state. The initial state is a state where effective information is not outputted to the signal line from the observation-subject device 10. As the state transition of the output signals included in the transaction, the state transition acquiring unit 174 acquires a set of output signals acquired during a period from acquisition of an output signal that is not in the initial state to immediately before an acquisition of an output signal that is in the initial state. The transaction may include a set of a fixed or variable number of output signals.

For the state transition of the output signal included in the transaction extracted by the transaction extracting unit 170, the state transition storing unit 102b, the state transition adding unit 110b, and the state transition counting unit 115b perform similar processing to the state transition storing unit 102a, the state transition adding unit 110a, and the state transition counting unit 115a. The state transition storing unit 102b, the state transition adding unit 110b, and the state transition counting unit 115b have substantially the same functions and configurations as those of the state transition storing unit 102a, the state transition adding unit 110a, and the state transition counting unit 115a, respectively, and accordingly, description thereof will be omitted below except where their respective functions are different.

The state transition outputting unit 120 outputs the state transitions of the output signals stored in the state transition storing unit 102a and 102b. The state transition outputting unit 120 according to this embodiment displays the state transitions of the output signals, which are stored in the state transition storing units 102a and 102b, to a user of the observation device 20. The state transition outputting unit 120 includes a tabular format display unit 122, a state transition diagram display unit 124, a timing chart display unit 126, and a histogram display unit 128.

The tabular format display unit 122 displays, the number of occurrences of the state transition corresponding to the set of the output signal acquired in one cycle and the output signal acquired in the next cycle. The state transition diagram display unit 124 displays the state transitions of the output signals stored in the state transition storing units 102a and 102b. The timing chart display unit 126 displays the state transitions of the output signals stored in the state transition storing units 102a and 102b. The histogram display unit 128 displays a histogram based on the number of occurrences of the state transitions of the output signals stored in the state transition storing units 102a and 102b.

The state transition selecting unit 130 allows the user of the observation device 20 to designate or select at least one state transition. The designated information storing unit 135 stores the state transition designated or selected by the user of the observation device 20. When a state transition corresponding to a set of output signals newly acquired from the output signal acquiring unit 100 meets a predetermined notification condition, the state transition notifying unit 140 notifies another observation device connected to the observation device 20 and/or notifies the state transition outputting unit 120 that the state transition meeting the notification condition has occurred.

For each of the state transitions for which a frequency is to be displayed on the histogram, the state transition retrieving unit 145 retrieves a state transition from the state transition storing units 102a and/or 102b. The frequency distribution calculating unit 150 calculates the frequency of the state transition to be displayed, based on the number of occurrences stored in the state transition storing units 102a and/or 102b correspondingly to the retrieved state transition, and supplies the frequency to the histogram display unit 128.

In the display of the timing chart, when there are plural candidates for a timing chart subsequent to a timing chart already displayed, the subsequent output signal selecting unit 160 allows the user to select the subsequent timing charts.

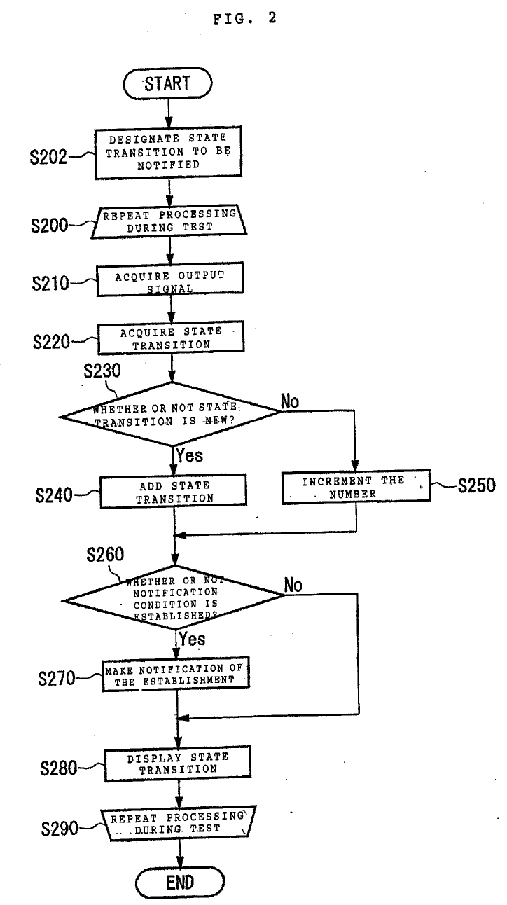

Referring now to FIG. 2, the operation of the observation device 20 according to the preferred embodiment is shown.

First, when at least one state transition to be flagged is designated by the user of the observation device 20, the state transition selecting unit 130 stores the designated state transition in the designated information storing unit 135 (Step S202). Next, when a test of the observation-subject device 10 is started, the observation device 20 repeats processing of S210 to S280 during the test (S200, S290).

During the test, the output signal acquiring unit 100 acquires the output signal outputted by the observation-subject device 10 for each cycle (S210). Next, the state transition adding unit 110a and/or the state transition adding unit 110b acquire the state transition of the output signal, which corresponds to the output signals acquired in the two or more continuous cycles (S220).

More specifically, the state transition adding unit 110a receives, as the state transition of the output signal, the set of output signals acquired in the two continuous cycles. Meanwhile, the state transition adding unit 110b receives, as the state transition of the output signal, the set of output signals included in the transaction extracted by the transaction extracting unit 170.

Next, when the set of newly acquired output signals is not stored in state transition storing units 102a and 102b (S230: Yes), the state transition adding units 110a and 110b store, as the state transition of the output signal, the set of newly acquired output signals in the state transition storing units 102a and 102b (S240).

More specifically, the state transition adding unit 110a determines whether the state transition corresponding to the set of newly acquired output signals is stored in the state transition identification information storing unit 104a. When the state transition of interest does not coincide with any of the state transitions stored in the state transition identification information storing unit 104a, it is determined that the state transition of interest is not stored in the state transition identification information storing unit 104a. Then, when the set of newly acquired output signals is not stored in the state transition identification information storing unit 104a or 104b, the state transition adding unit 110a stores the set of output signals of interest and state transition identification information (newly assigned to the set of output signals of interest in association with each other) in the state transition identification information storing unit 104a. Moreover, the state transition adding unit 110a initializes the number of occurrences of the state transition identified by the state transition identification information, which is stored in the state transition count storing unit 106a. During initialization, the state transition adding unit 110a may set the number of occurrences at 1.

When the state transition acquired by the state transition acquiring unit 174 is not stored in the state transition storing unit 102b, the state transition adding unit 110b adds and stores the state transition concerned to/in the state transition storing unit 102b in a manner similar to the state transition adding unit 110a.

Meanwhile, when the set of newly acquired output signals is stored in the state transition storing units 102a and 102b (S230: No), the state transition counting units 115a and 115b increment the number of occurrences of the state transition corresponding to the set of output signals of interest, which is stored in the state transition storing units 102a and 102b (S250).

More specifically, when the state transition corresponding to the set of newly acquired output signals is stored in the state transition identification information storing unit 104a, the state transition adding unit 110a reads the state transition identification information associated with the set of output signals of interest from the state transition identification information storing unit 104a, and supplies the state transition identification information to the state transition counting unit 115a. The state transition counting unit 115a increments the number of occurrences of the state transition, which is stored in the state transition count storing unit 106a corresponding to the state transition identification information.

Next, when the condition where the occurrence of the state transition to be flagged is established (S260: Yes), the state transition notifying unit 140 notifies the state transition outputting unit 120 and/or the other observation device that the condition has been established (S270).

The state transition notifying unit 140 according to this embodiment notifies that the condition has been established in the cases illustrated below.

(1) The state transition notifying unit 140 receives the state transition corresponding to the set of output signals newly acquired by the output signal acquiring unit 100 from the state transition adding unit 110a. When the state transition coincides with the state transition corresponding to the set of output signals stored in the designated information storing unit 135, the state transition notifying unit 140 notifies the state transition output unit 120 and/or the other observation device that the state transition coinciding with the state transition designated by the user of the observation device 20 has occurred. Thus, the observation device 20 can start debugging by using, as a trigger, the occurrence of the designated state transition. Moreover, by taking the occurrence of the state transition as a trigger signal, the observation device 20 can allow the logic analyzer to gather signals, or can store the signals gathered in a range from before the occurrence of the state transition to after the occurrence thereof.

(2) The state transition notifying unit 140 receives the number of occurrences of the state transition corresponding to the set of output signals newly acquired by the output signal acquiring unit 100 from the state transition counting unit 115a. When the number is less than a predetermined threshold value, the state transition notifying unit 140 indicates that the state transition has occurred. Setting of the threshold value enables the observation device 20 to start the debugging process and to allow the capture and storing of the signals to be observed, by taking, as a trigger, an occurrence of a low frequency state transition. Note that the threshold value may be set at 2 so as to make a notification only of a state transition occurring for the first time.

Next, the state transition output unit 120 displays the state transition of the output signal, which is stored in the state transition storing unit 102a and/or the state transition storing unit 102b, in various formats (S280). Moreover, when the user of the observation device 20 selects the state transition displayed on the screen and designates the state transition to be notified, the state transition selection unit 130 stores the selected state transition in the designated information storing unit 135.

According to the observation device 20 as described above, the number of occurrences of the state transition of the output signal outputted by the observation-subject device 10 is counted, thus making it possible to appropriately notify that the state transition in which the frequency of occurrences is low has occurred and so on when they happen. By such notification, the other observation device can store signal values before and after the occurrence of the state transition of interest. Hence, according to the observation device 20, an operation having a high possibility to cause a problem can be appropriately selected, data can be captured therefrom, and the debugging of the logic circuit can be performed efficiently, without entirely storing the time series data of the output signals.

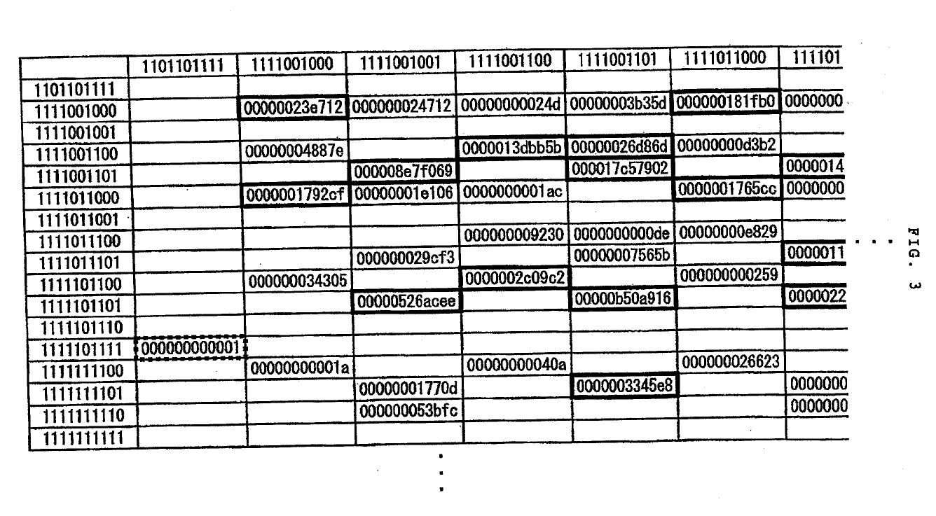

FIG. 3 shows an example of the tabular format display by the observation device 20 according to the preferred embodiment.

The tabular format display unit 122 in the observation device 20 acquires, from the state transition storing unit 102a, the number of occurrences of each state transition corresponding to the set of output signals acquired in the two continuous cycles, and displays the number of occurrences by the tabular format. Specifically, the tabular format display unit 122 displays the number of occurrences of the state transition corresponding to the set of the output signals acquired in one cycle and the output signal acquired in the next cycle to the one cycle on a cell of a table in which the output signal acquired in the one cycle is arranged in the row direction and the output signal acquired in the next cycle is arranged in the column direction. Alternatively, the tabular format display unit 122 may display the respective cells so that the output signal acquired in the one cycle is arranged in the column direction and the output signal acquired in the next cycle is arranged in the row direction. Thus, the user of the observation device 20 can appropriately capture the number of occurrences of each state transition.

Moreover, the tabular format display unit 122 displays a cell displaying a state transition that has occurred a predetermined number of times by a display format capable of distinguishing the cell from a cell displaying a state transition that has not occurred such predetermined times. For example, the tabular format display unit 122 bolds a contour of the cell displaying the state transition that has occurred a predetermined number of times, varies a background color of the cell differently from that of the other cells, and varies color/font/boldness of characters in the cell differently from those in the other cells, thus emphatically displaying that the state transition occurs many times. Thus, the user of the observation device 20 can recognize that a particular state transition has occurred many times without reading the number of occurrences of the state transition. Note that, alternatively, the tabular format display unit 122 may emphatically display a cell in which a state transition has occurred less frequently than such predetermined times.

Moreover, the tabular format display unit 122 may display a cell for a state transition corresponding to a set of output signals acquired in the last predetermined period of time by a display format capable of distinguishing the cell from a cell displaying a state transition corresponding to a set of output signals which are not acquired in the last predetermined period of time.

Moreover, the state transition selecting unit 130 allows the user to select at least one cell corresponding to the state transition to be notified by the state transition notifying unit 140 from among the respective cells displayed by the tabular format display unit 122. Then, the state transition selecting unit 130 records the state transition concerned in the designated information storing unit 135. As a result, the state transition notifying unit 140 can notify that a state transition coinciding with the selected state transition has occurred when the state transition corresponding to the set of output signals newly acquired by the output signal acquiring unit 100 coincides with the state transition corresponding to the selected state transition.

According to the tabular format display unit 122 described above, the state transition of the output signal of the observation-subject device 10 can be plainly displayed by the tabular format, and a user interface easy to operate for the user can be provided.

Note that the tabular format display unit 122 may calculate the number of occurrences of a state transition in adjacent two cycles based on the number of occurrences of each state transition stored in the state transition storing unit 102b, and may display the calculated number of occurrences by a tabular format similar to the above. For example, when a first transition (A→B→C→A→B) is counted twice and a second transition (D→A→B) is counted three times, two state transitions (A→B) are included in the first state transition, and one state transition (A→B) is included in the second state transition, and accordingly, the tabular format display unit 122 may calculate such that the state transition (A→B) has occurred seven times (2×2+3) in total.

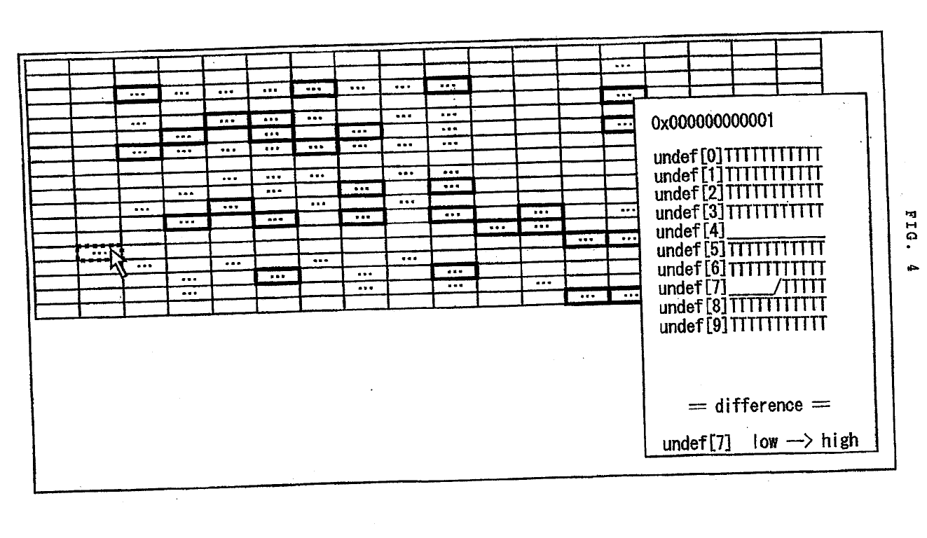

FIG. 4 is a timing chart showing the state transition corresponding to a certain cell in the display of the display format by the observation device 20 according to the preferred embodiment. When one cell is designated from the user in the case of displaying each state by the tabular format, the tabular format display unit 122 displays a timing chart showing a change of the output signal in the state transition corresponding to the cell concerned.

Thus, the user of the observation device 20 can capture the state transition corresponding to each cell more easily.

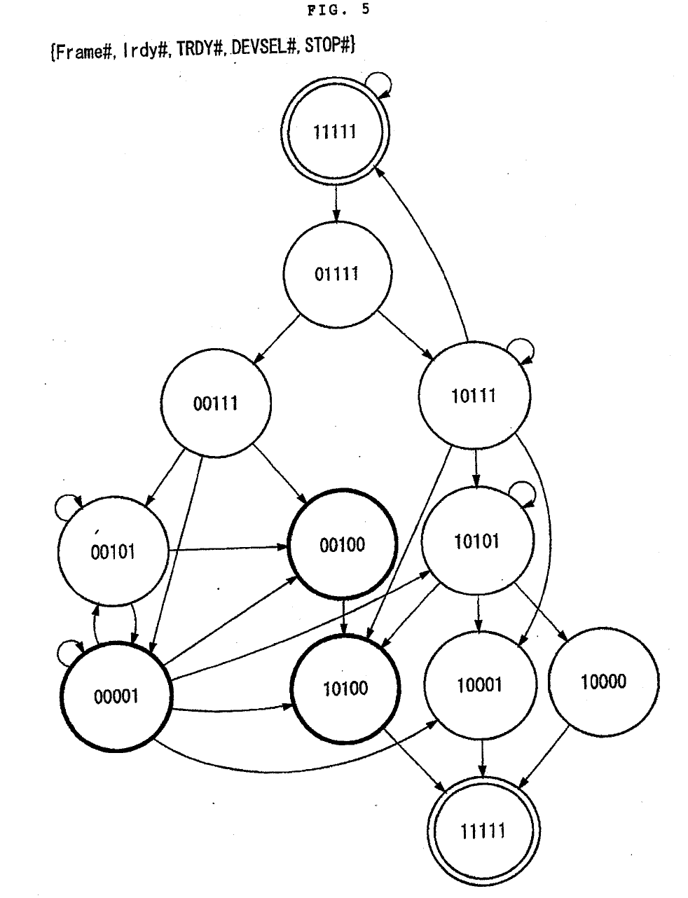

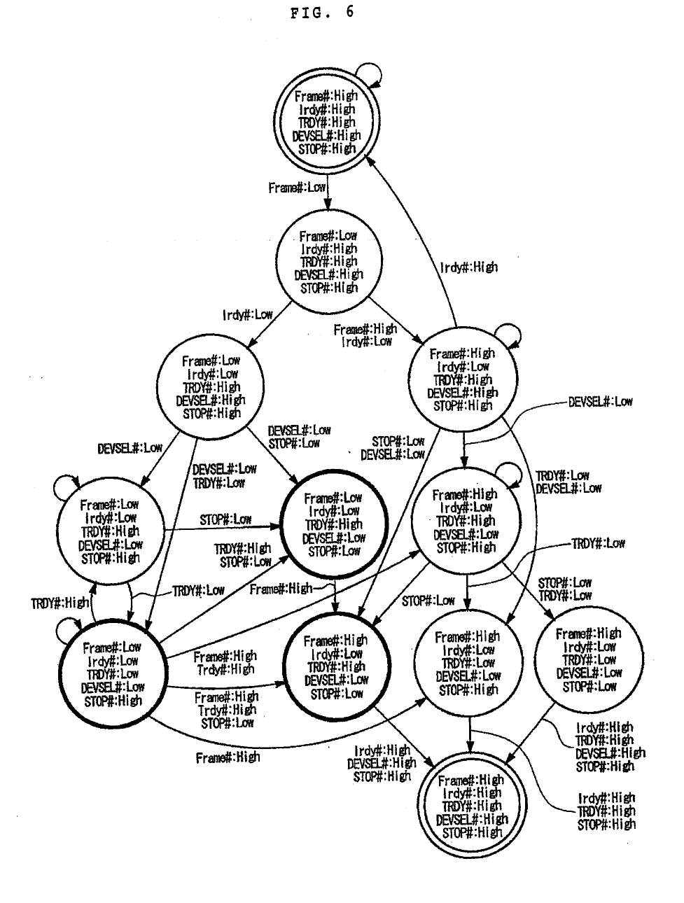

FIGS. 5 and 6 show examples of reduced display and expanded display of state transition diagrams by the observation device 20 according to the preferred embodiment.

The state transition diagram display unit 124 in the observation device 20 displays the state transition corresponding to the set of output signals stored in the state transition storing units 102a and/or 102b by the state transition diagram. Specifically, the state transition diagram display unit 124 displays each of the output signals acquired in each cycle as a node (single circle or double circle in FIGS. 5 and 6) showing the state of the output signal. Moreover, the state transition diagram display unit 124 displays the state transition corresponding to the set of output signals acquired in two continuous cycles as a link (arrow in FIGS. 5 and 6) from a node showing the output signal in the first cycle to a node showing the output signal in the second cycle.

When the state transition of the output signal is acquired by the transaction extracting unit 170, the state transition adding unit 110b, the state transition counting unit 115b and the state transition storing unit 102b for each transaction, the state transition diagram display unit 124 displays nodes corresponding to head and tail output signals of the transaction so as to be distinguishable from intermediate nodes. In FIGS. 5 and 6, the head and tail nodes are shown by double circles, and the intermediate nodes are shown by single circles.

The state transition diagram display unit 124 changes a size of the state transition diagram displayed on the screen in accordance with an instruction from the user. In the case of displaying the state transition diagram at less than a predetermined size (reduced display), the state transition diagram display unit 124 displays each node and each link by a display format for the reduced display. Specifically, for example as shown in FIG. 5, the state transition diagram display unit 124 collectively displays a data value of the output signal corresponding to each node as a binary or hexadecimal value. Moreover, the state transition diagram display unit 124 does not display information indicating a corresponding signal change for each link.

Meanwhile, in the case of displaying the state transition diagram at the predetermined size or more (expanded display), the state transition diagram display unit 124 displays each node and each link by a display format for the expanded display. Specifically, for example as shown in FIG. 6, for the output signal corresponding to each node, the state transition diagram display unit 124 individually displays a name and value of each bit included in the output signal. Moreover, the state transition diagram display unit 124 displays the information indicating the corresponding signal change for each link.

Here, the state transition diagram display unit 124 displays a node, an arc, or a set of plural nodes and at least one arc, which displays the state or state transition that has occurred at predetermined times by a display format capable of distinguishing the node, the arc, or the set of plural nodes and at least one arc from a node, an arc, or a set of plural nodes and at least one arc, which displays the state transition that has not occurred at such predetermined times. Specifically, the state transition display unit 124 bolds an outer circumference of the node or the arc, which displays the state transition that has occurred a predetermined number of times, changes a color of the node or the arc to a different one from those of the other nodes or arcs, thus emphatically displaying that the state or state transition has occurred many times. Alternatively, the state transition diagram display unit 124 may emphatically display a node or an arc, which displays a state or a state transition that has occurred less than such a predetermined number of times.

Moreover, the state transition diagram display unit 124 may display a node, an arc, or a set of plural nodes and at least one arc, which displays the state transition corresponding to the set of output signals acquired in the last predetermined period of time by a display format capable of distinguishing the node, the arc, or the set of plural nodes and at least one arc from a node, an arc, or a set of plural nodes and at least one arc, which displays the state transition corresponding to the set of output signals that is not acquired in the last predetermined period of time.

Moreover, the state transition selecting unit 130 allows the user of the observation device 20 to select at least one link or at least two nodes, which are displayed by the state transition diagram display unit 124. Then, the state transition selecting unit 130 records a state transition of interest in the designated information storing unit 135. As a result, when the state transition corresponding to the set of output signals newly acquired by the output signal acquiring unit 100 coincides with the state transition corresponding to the selected link or at least two nodes, the state transition notifying unit 140 can identify that the state transition coinciding with the selected state transition has occurred. In this case, the state transition diagram display unit 124 may add a new node and/or arc based on the instruction from the user, and may allow the user to select the added node and/or arc.

According to the state transition diagram display unit 124 described above, the state transition of the output signal of the observation-subject device 10 can be plainly displayed by the state transition diagram, and the user interface easy to operate for the user can be provided.

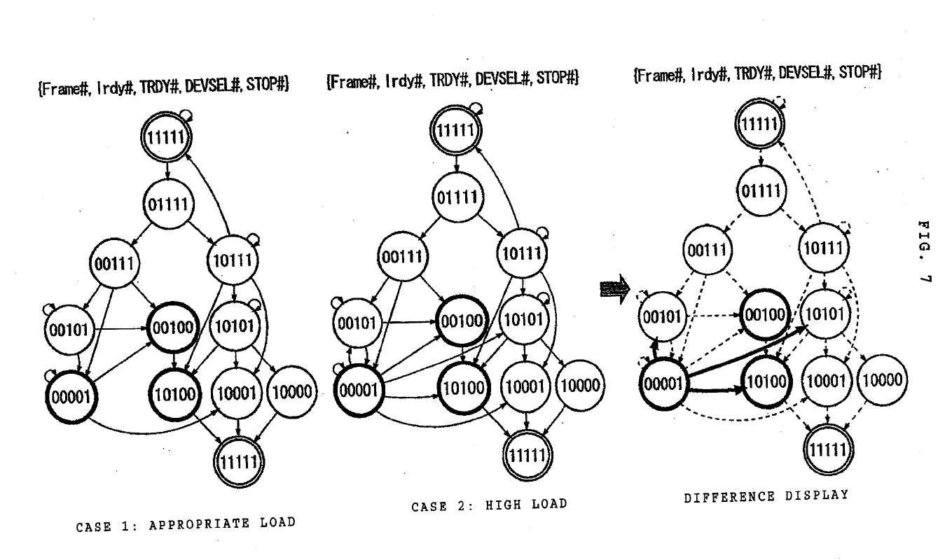

FIG. 7 shows an example of comparison displays of the state transitions by the observation device 20 according to the preferred embodiment.

The state transition diagram display unit 124 according to this embodiment has a function to compare plural state transition diagrams with each other. Specifically, for example, the state transition diagram display unit 124 compares a first state transition diagram obtained from a result of a test executed immediately before with a second state transition diagram designated by the user of the observation device 20, and displays links, which are not included in the second state transition diagram though are displayed on the first state transition diagram, so as to be distinguishable from links included in the second state transition diagram.

In an example shown in FIG. 7, the state transition diagram display unit 124 first creates the second state transition diagram (case 1) based on an output signal acquired in a state of adding an appropriate processing load to the observation-subject device 10, and stores the second state transition diagram in the state transition diagram display unit 124. Next, the state transition diagram display unit 124 creates the first state transition diagram (case 2) based on an output signal acquired in a state of adding a high processing load to the observation-subject device 10, and compares the first state transition diagram with the second state transition diagram. As a result of the comparison, the state transition diagram display unit 124 emphatically displays the links, which are not included in the second state transition diagram though are displayed on the first state transition diagram. By this comparison, the state transition diagram display unit 124 can display the state transitions occurring only in the case of the high load so as to be distinguishable, and can assist the debugging of a failure occurring only in the case of the high load.

Note that the state transition diagram display unit 124 may use a state transition diagram created by the state transition diagram display unit 124 based on an output signal acquired during a normal operation of the observation-subject device 10 as the second state transition diagram to be compared with the first state transition diagram.

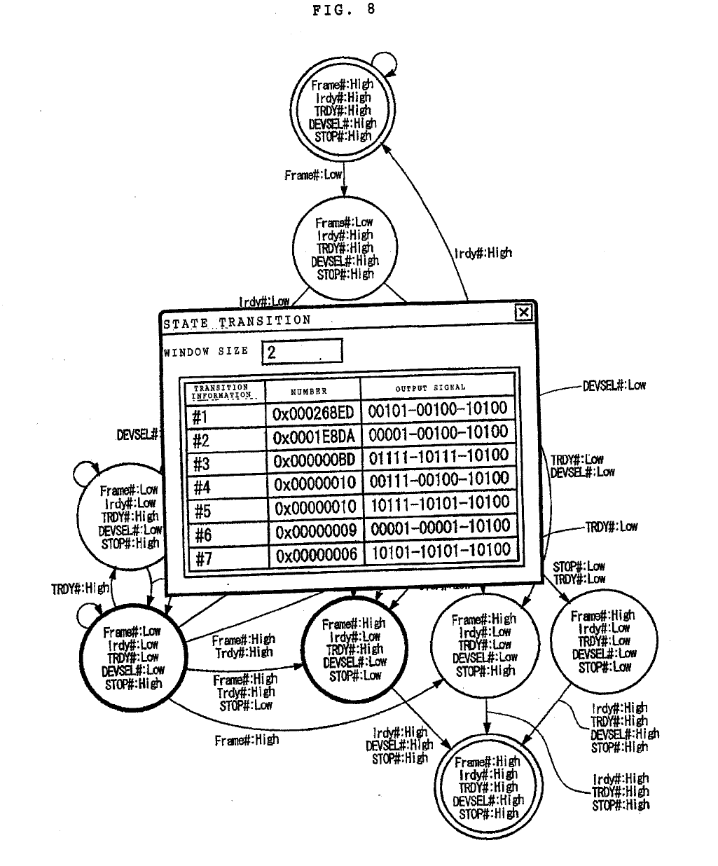

FIG. 8 shows an example of selection display of the state transition by the observation device 20 according to the preferred embodiment.

When the user sequentially selects at least two nodes, the state transition diagram display unit 124 displays a list of partial state transitions passing through these nodes in order on a pop-up window. In this embodiment, the state transition diagram display unit 124 displays numbers for identifying the state transitions, the numbers of occurrences of the state transitions, and the sets of output signals as the list of the state transitions as described above. When any of the state transitions is selected on the window displaying the list of the state transitions, the state transition diagram display unit 124 displays a set of nodes and a link, which corresponds to the state transition of interest.

According to the state transition diagram display unit 124 described above, it is possible to appropriately select the partial state transition equivalent to a part of the transaction from the entire state transition diagram.

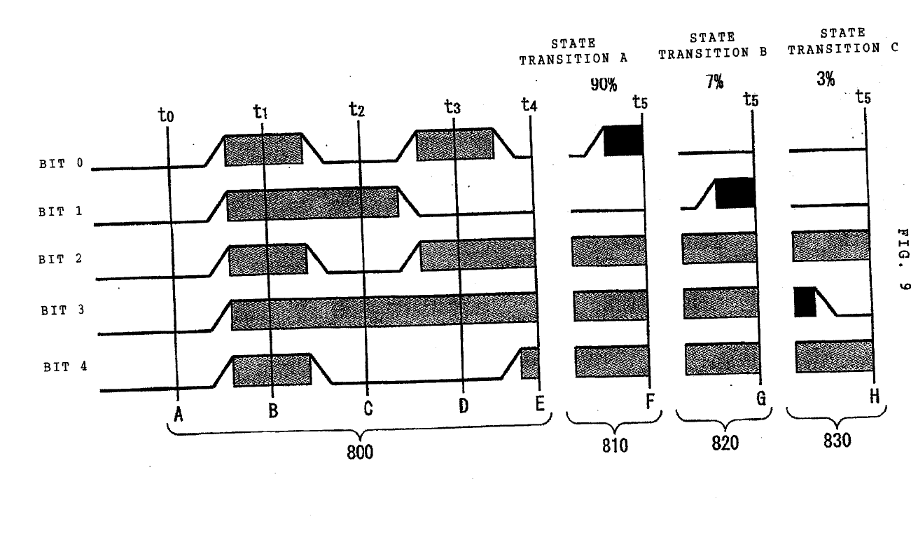

FIG. 9 shows a display of timing charts by the observation device 20 according to the preferred embodiment.

The timing chart display unit 126 in the observation device 20 displays each state transition stored in the state transition storing unit 102a and/or 102b. Here, when a first set of output signals and a second set of output signals in which one or more output signals from a head output signal take the same values are acquired, the timing chart display unit 126 displays the one or more output signals taking the same values, at least one output signal subsequent to the one or more output signals concerned in the first set of output signals, and at least one output signal subsequent to the one or more output signals concerned in the second set of output signals, individually as the timing charts.

For example, when a state transition A corresponding to a set A (A→B→C→D→E→F) of output signals, a state transition B corresponding to a set B (A→B→C→D→E→G) of output signals, and a state transition C corresponding to a set C (A→B→C→D→E→H) of output signals are stored in the state transition storing unit 102b, one timing chart 800 of output signals (A→B→C→D→E) taking the same values is displayed. Moreover, a timing chart 810 of the output signal F subsequent to the timing chart 800 in the set A of output signals, a timing chart 820 of the output signal G subsequent to the timing chart 800 in the set B of output signals, and a timing chart 830 of the signal H subsequent to the timing chart 800 in the set C of output signals, are displayed.

The timing chart display unit 126 according to this embodiment displays the timing charts 800 to 830 of the respective output signals subsequent to the output signals taking the same values while arraying the timing charts 810 to 830 in the lateral direction so as to be visually recognizable at the same time, and makes the timing charts 810 to 830 selectable by the user. Moreover, the timing chart display unit 126 displays frequencies of occurrences of the state transitions in association with the timing charts 810 to 830 of the respective output signals subsequent to the output signals taking the same values.

Next, the subsequent output signal selecting unit 160 allows the user of the observation device 20 to select either at least one subsequent output signal in the first set of output signals or at least one subsequent output signal in the second set of output signals, which is displayed by the timing chart display unit 126. Specifically, in this example, the subsequent output signal selecting unit 160 allows the user to select any of the timing charts 810 to 830, thereby allowing the user to select the output signal F, G or H.

Then, when the at least one subsequent output signal in the first set of output signals is selected, the timing chart display unit 126 displays the one or more output signals taking the same values and the at least one output signal in the first set of output signals, for example, as one timing chart. Meanwhile, the timing chart display unit 126 deletes the display of a timing chart for the at least one subsequent output signal in the unselected second set of output signals.

Here, when the first set (for example, A→B→C→D→E→F→X→Y→Z) of output signals, the second set (A→B→C→D→E→G) of output signals in which n1 pieces (for example, five) of output signals from the head output signal take the same values as those of the first set of output signals, and a third set (for example, A→B→C→D→E→F→X→Y→W) of output signals in which n2 pieces of output signals from the head output signal take the same values as those of the first set of output signals, the n2 being larger than the n1 (n2>n1), are acquired, the timing chart display unit 126 can perform the following display.

First, the timing chart display unit 126 displays, individually as timing charts, the n1 pieces of output signals (A→B→C→D→E), at least one output signal (for example, F) subsequent to the n1 pieces of output signals, which is common to the first set of output signals and the third set of output signals, and at least one output signal (for example, G) subsequent to the n1 pieces of output signals in the second set of output signals.

Next, when the at least one output signal (for example, F) common to the first set of output signals and the third set of output signals is selected, the n2 pieces of output signals (for example, A→B→C→D→E→F→X→Y) common to the first set of output signals and the third set of output signals, at least one output signal (for example, Z) in the first set of output signals, which is subsequent to the n2 pieces of output signals common to the first set of output signals and the third set of output signals, and at least one output signal (for example, W) in the third set of output signals, which is subsequent to the n2 pieces of output signals common to the first set of output signals and the third set of output signals, are displayed, and is allowed to be selected by the user.

According to the timing chart display unit 126 described above, the output signals in the set, which are included in the transaction, can be displayed in order from the head by the timing chart, and for each transaction in which a portion is common to the already displayed portion, at least one output signal subsequent to the already displayed portion can be displayed. Then, when any of the subsequent output signals is selected, the set of output signals can be redisplayed by the timing chart including the selected output signal in the common portion. Thus, the timing chart display unit 126 sequentially selects the selectively displayed timing charts, thus making it possible to provide a user interface capable of sequentially specifying the transactions from the head.

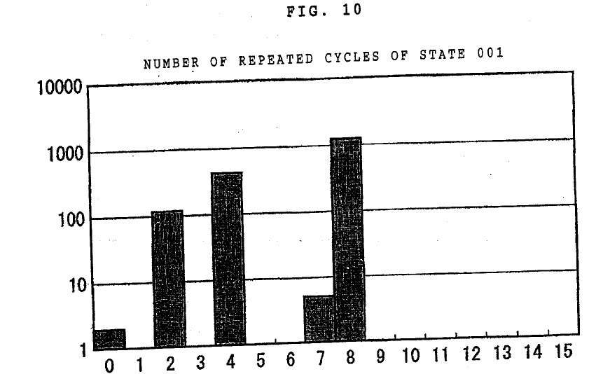

FIG. 10 shows a display of a histogram by the observation device 20 according to the preferred embodiment.

The histogram display unit 128 in the observation device 20 displays a frequency distribution where strings of output signals designated by the user are outputted continuously and repeatedly. First, the state transition retrieving unit 145 retrieves a state transition corresponding to a set of output signals, which includes the strings of output signals designated by the user of the observation device 20 from the state transition identification information storing unit 104a in the state transition storing unit 102a and/or the state transition identification information storing unit 104b in the state transition storing unit 102b. Then, the state transition retrieving unit 145 supplies the relevant state transition and the number of occurrences thereof to the frequency distribution calculating unit 150. Next, the frequency distribution calculating unit 150 calculates the number of strings of output signals that are continuously included in each of the state transitions retrieved by the state transition retrieving unit 145. Such a string of output signals may be one output signal or a set of plural output signals. For example, the number where a string (B) of output signals is included in a state transition (A→B→B→B→D) is three. Then, when the number of occurrences of the state transition concerned is 100, a frequency where the string (B) of output signals appears continuously three times with regard to the state transition concerned becomes 300.

Next, the frequency distribution calculating unit 150 calculates a frequency distribution of the number where the string of output signals is repeatedly outputted, based on the calculated number and the retrieved number of occurrences of the state transition. Specifically, the frequency distribution calculating unit 150 classifies the number of the string of output signals that are repeatedly outputted into classes, and sums the number of occurrences for each class, thus calculating the frequency distribution. Then, the histogram display unit 128 displays the frequency distribution.

Moreover, the state transition selecting unit 130 allows the user of the observation device 20 to select a notification condition for the number where the string of output signals is repeatedly outputted. Then, the state transition selecting unit 130 records the state transition and continuously includes the designated number of strings of output signals in the designated information storing unit 135. As a result, when the state transition corresponding to the set of output signals newly acquired by the output signal acquiring unit 100 continuously includes the designated number of strings of output signals, the state transition notifying unit 140 can determine that the state transition continuously including the designated number of strings of output signals has occurred.

Moreover, for each number where the string of output signals is repeatedly outputted, under a condition where the frequency corresponding to the number concerned is smaller than a preset threshold value, the histogram display unit 128 may instruct the state transition selecting unit 130 to make a notification of an occurrence of the state transition continuously including the number concerned of strings of output signals. Thus, the state transition selecting unit 130 records a state transition meeting the condition in the designated information storing unit 135. As a result, in the case where the state transition corresponding to the set of output signals newly acquired by the output signal acquiring unit 100 continuously includes a certain number of strings of output signals, when a frequency corresponding to the number concerned is smaller than the threshold value, the state transition notifying unit 140 can determine that a state transition continuously including the number concerned of strings of output signals has occurred.

According to the histogram display unit 128 described above, the distribution of the numbers where a certain string of output signals is continuously outputted can be plainly displayed, and based on the distribution, it is made possible to appropriately set the condition for making the notification of the occurrence of the state transition.

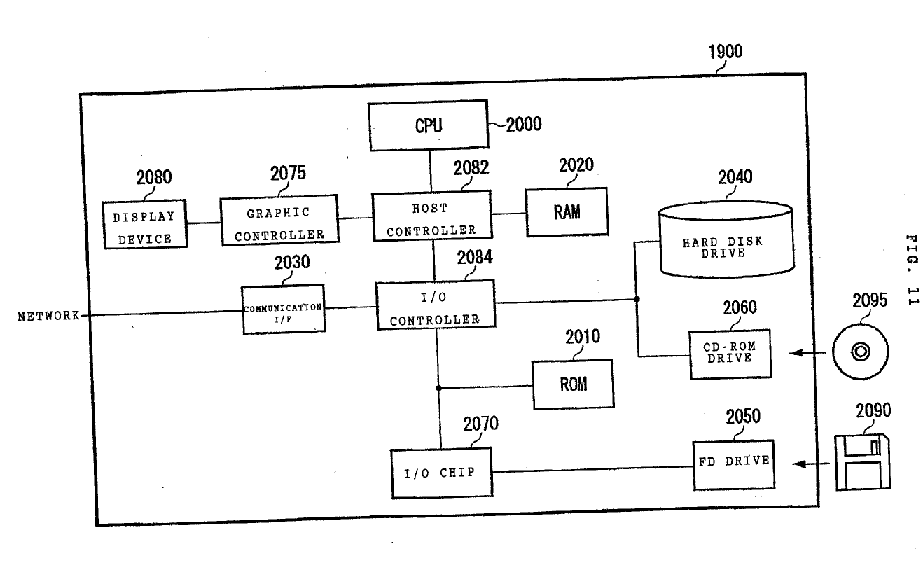

FIG. 11 shows a hardware configuration of a computer 1900 according to the preferred embodiment. The computer 1900 according to this embodiment includes a CPU and its peripheral unit having a CPU 2000, a RAM 2020, a graphic controller 2075, and a display device 2080, which are interconnected by a host controller 2082, an input/output unit having a communication interface 2030, a hard disk drive 2040, and a CD-ROM drive 2060, which are connected to the host controller 2082 by an input/output controller 2084, and a legacy input/output unit having a ROM 2010, a flexible disk drive 2050, and an input/output chip 2070, which are connected to the input/output controller 2084.

The host controller 2082 connects the RAM 2020 to the CPU 2000 and the graphic controller 2075, which access the RAM 2020 at a high transfer rate. The CPU 2000 operates based on programs stored in the ROM 2010 and the RAM 2020, and controls the respective units. The graphic controller 2075 acquires image data created on a frame buffer provided in the RAM 2020 by the CPU 2000, and displays an image on the display device 2080 based on the image data. Alternatively, the graphic controller 2075 may include, in the inside thereof, a frame buffer that stores image data created by the CPU 2000.

The input/output controller 2084 connects the host controller 2082 to the communication interface 2030, the hard disk drive 2040, and the CD-ROM drive 2060, which are relatively high-speed input/output devices. The communication interface 2030 communicates with an external device through a network. The hard disk drive 2040 stores programs and data for use in the CPU 2000 in the computer 1900. The CD-ROM drive 2060 reads programs or data from a CD-ROM 2095, and provides the programs or the data to the hard disk drive 2040 through the RAM 2020.

Moreover, relatively low-speed input/output devices which are the ROM 2010, the flexible disk drive 2050 and the input/output chip 2070 are connected to the input/output controller 2084. The ROM 2010 stores a boot program executed by the computer 1900 when the computer 1900 is activated, a program depending on hardware of the computer 1900. The flexible disk drive 2050 reads programs or data from a flexible disk 2090, and provides the programs or the data to the hard disk drive 2040 through the RAM 2020. The input/output chip 2070 connects the flexible disk drive 2050 and various input/output devices through, for example, a parallel port, a serial port, a keyboard port, a mouse port.

Each of the programs provided to the hard disk drive 2040 through the RAM 2020 is stored in a storing medium such as the flexible disk 2090, the CD-ROM 2095 and an IC card, and is provided by the user. The program is read out from the storing medium, installed in the hard disk drive 2040 in the computer 1900 through the RAM 2020, and executed in the CPU 2000.

The programs, which are installed in the computer 1900 and allow the computer 1900 to function as the observation device 20, include an output signal acquiring module; a state transition storage managing module having a state transition identification information storage managing module and a state transition count storage managing module; a state transition adding module; a state transition counting module; a state transition outputting module having a tabular format display module, a state transition diagram display module, a timing chart display module, and a histogram display module; a state transition selecting module; a designated information storage managing module; a state transition notifying module; a state transition retrieving module; a frequency distribution calculating module; a subsequent output signal selecting module; and a transaction extracting module having an initial state detecting module and a state transition acquiring module. By requesting the CPU 2000, the programs or the modules allow the computer 1900 to function as: the output signal acquiring unit 100; the state transition storing units 102a and 102b having the state transition identification information storing units 104a and 104b and the state transition count storing units 106a and 106b; the state transition adding units 110a and 110b; the state transition counting units 115a and 115b; the state transition outputting unit 120 having the tabular format display unit 122, the state transition diagram display unit 124, the timing chart display unit 126, and the histogram display unit 128; the state transition selecting unit 130; the designated information storing unit 135; the state transition notifying unit 140; the state transition retrieving unit 145; the frequency distribution calculating unit 150; the subsequent output signal selecting unit 160; and the transaction extracting unit 170 having the initial state retrieving unit 172 and the state transition acquiring unit 174.

The programs or the modules which are described above may be stored in an external storing medium. An optical storing medium such as a DVD and a CD, a magneto-optical storing medium such as an MO, a tape medium, a semiconductor memory such as an IC card, and the like, can be used as such a storing medium besides the flexible disk 2090 and the CD-ROM 2095. Moreover, a storage device such as a hard disk and a RAM which are provided in a server system connected to a private communication network and the Internet may be used as such a storing medium, and the programs may be provided to the computer 1900 through such a network.

As above, the present invention has been described according to the preferred embodiment. However, the technical scope of the present invention is not limited to the scope described in the above-described embodiment. It will be apparent for those skilled in the art that various alterations or modifications can be added to the above-described embodiment. Similarly, from the description of the scope of claims an aspect added with such alterations or modifications can also be incorporated in the technical scope of the present invention.

Although the preferred embodiment of the present invention has been described in detail, it should be understood that various changes, substitutions and alternations can be made therein without departing from spirit and scope of the inventions as defined by the appended claims.

What is claimed is:

1. A logic verification tool having an observation device for receiving a signal outputted by a logic unit to be observed, comprising:
an output signal acquiring unit for acquiring an output signal which is outputted by the logic unit to be observed;
a state transition storing unit for storing a set of a partial signal outputs corresponding to a sequence of two or more cycles, as a state transition of the output signal, wherein the output signal is acquired through the sequence of two or more cycles;
a state transition adding unit for causing the state transition storing unit to additionally store a set of newly acquired partial signal outputs corresponding to a sequence of two or more cycles corresponding to a series of two or more cycles, as a new state transition, wherein a state transition corresponding to the set concerning the newly acquired output signal has not been stored in the state transition storing unit; and
a state transition outputting unit for outputting a state transition of output signals which have been stored in the state transition storing unit.

2. The observation device according to claim 1, wherein the state transition storing unit stores the number of occurrences of each state transition of the output signal corresponding to the state transition, and
the observation device further comprises a state transition counting unit for incrementing the number of occurrences of the state transition when the state transition corresponding to the set of output signals newly acquired by the output signal acquiring unit is stored in the state transition storing unit.

3. The observation device according to claim 2,
wherein the state transition storing unit includes:
a state transition identification information storing unit for storing the set of output signals and state transition identification information for identifying the state transition corresponding to the set of output signals in association with each other; and
a state transition count storing unit for storing the state transition identification information and the number of occurrences of the state transition identified by the state transition identification information in association with each other,
wherein the state transition adding unit stores, when the set of newly acquired output signals is not stored in the state transition identification information storing unit, the set of output signals and the state transition identification information newly assigned to the set of output signals in association with each other in the state transition identification information storing unit, initializes the number of occurrences of the state transition identified by the state transition identification information, the number being stored in the state transition count storing unit, and when the set of newly acquired output signals is stored in the state transition identification information storing unit, reads the state transition identification information associated with the set of output signals from the state transition identification information storing unit, and
wherein the state transition counting unit increments the number stored in the state transition count storing unit correspondingly to the state transition identification information when the set of newly acquired output signals is stored in the state transition identification information storing unit.

4. The observation device according to claim 2, further comprising a state transition notifying unit for notifying, when the number of occurrences of the state transition corresponding to the set of output signals newly acquired by the output signal acquiring unit is less than a predetermined threshold value, that the state transition has occurred.

5. The observation device according to claim 2, further comprising:
a designated information storing unit for storing the state transition designated by the user of the observation device; and
a state transition notifying unit for notifying, when the state transition corresponding to the set of output signals newly acquired by the output signal acquiring unit coincides with the state transition corresponding to the set of output signals stored in the designated information storing unit, that a state transition coinciding with the designated state transition has occurred.

6. The observation device according to claim 2, wherein the state transition outputting unit includes a tabular format display unit for displaying the number of occurrences of the state transition corresponding to a set of the output signal acquired in one cycle and the output signal acquired in the next cycle to the one cycle on a cell of a table in which the output signal acquired in the one cycle is arranged in any one of the row direction and the column direction and the output signal acquired in the next cycle to the one cycle is arranged in the other of the row direction and the column direction.

7. The observation device according to claim 6, wherein the tabular format display unit displays a cell displaying the state transition that has occurred predetermined times or more by a display format capable of distinguishing the cell from a cell displaying the state transition that has not occurred predetermined times or more.

8. The observation device according to claim 6, further comprising:
a state transition selecting unit for allowing the user of the observation device to select at least one cell; and
a state transition notifying unit for notifying, when the state transition corresponding to the set of output signals newly acquired by the output signal acquiring unit coincides with the state transition corresponding to the selected cell, that a state transition coinciding with the selected state transition has occurred.

9. The observation device according to claim 2,
wherein the state transition outputting unit includes a state transition diagram display unit for displaying a state transition diagram, in which the output signal acquired in each cycle is displayed as a node, and the state transition corresponding to the set of output signals acquired in two continuous cycles is displayed as a link from the node showing the output signal in the first cycle to the node showing the output signal in the second cycle, and
the observation device further comprises:
a state transition selecting unit for allowing the user of the observation device to select either at least one link or at least two nodes; and
a state transition notifying unit for notifying, when the state transition corresponding to the set of output signals newly acquired by the output signal acquiring unit coincides with the state transition corresponding to either the selected link or the selected two nodes, that a state transition coinciding with the selected state transition has occurred.

10. The observation device according to claim 8,
wherein the state transition outputting unit includes a state transition diagram display unit for displaying a state transition diagram, in which the output signal acquired in each cycle is displayed as a node, and the state transition corresponding to the set of output signals acquired in two continuous cycles is displayed as a link from the node showing the output signal in the first cycle to the node showing the output signal in the second cycle, and
the state transition diagram display unit displays the link which is not included in the second state transition diagram designated by the user of the observation device though is displayed on the first state transition diagram so as to be distinguishable from the link included in the second state transition diagram.

11. The observation device according to claim 2, further comprising:
a state transition retrieving unit for retrieving the state transition corresponding to the set of output signals including a string of output signals designated by the user of the observation device from the state transition storing unit; and
a frequency distribution calculating unit for calculating a frequency distribution of the number where the string of output signals is repeatedly outputted, based on the number where the strings of output signals are continuously included in each of the state transitions retrieved by the state transition retrieving unit,
wherein the state transition outputting unit includes a histogram display unit for displaying a histogram of the frequency distribution calculated by the frequency distribution calculating unit.

12. The observation device according to claim 1,
wherein the state transition outputting unit includes a timing chart display unit for displaying as timing charts, when a first set of output signals and a second set of output signals in which a predetermined number of the output signals from a head output signal take the same values are acquired, the predetermined number of output signals, at least one output signal subsequent to the predetermined number of output signals in the first set of output signals, and at least one output signal subsequent to the predetermined number of output signals in the second set of output signals.

13. The observation device according to claim 12, further comprising:
a subsequent output signal selecting unit for allowing the user of the observation device to select either the at least one output signal in the first set of output signals or the at least one output signal in the second set of output signals, both of the at least one signals being displayed by the timing chart display unit,
wherein, when the at least one output signal in the first set of output signals is selected, the timing chart display unit displays the predetermined number of output signals and the at least one output signal in the first set of output signals, and deletes display of the at least one output signal in the second set of output signals.

14. The observation device according to claim 13,
wherein, when the first set of output signals, the second set of output signals, and a third set of the output signals in which the output signals of which the number from the head output signal is larger than the predetermined number take the same values as values of the first set of output signals, are acquired,
the timing chart display unit displays:
as timing charts, the predetermined number of output signals, at least one output signal subsequent to the predetermined number of output signals, the at least one output signal being common to the first set of output signals and the third set of output signals, and at least one output signal subsequent to the predetermined number of output signals in the second set of output signals; and
the timing chart display unit further displays:
when the at least one output signal common to the first set of output signals and the third set of output signals is selected, the output signals common to the first set of output signals and the third set of output signals, the number thereof being larger than the predetermined number, at least one output signal in the first set of output signals, the at least one output signal being subsequent to the larger number of output signals common to the first set of output signals and the third set of output signals, and at least one output signal in the third set of output signals, the at least one output signal being subsequent to the larger number of output signals common to the fist set of output signals and the third set of output signals.

15. The observation device according to claim 1, further comprising:
an initial state detecting unit for detecting that, when the output signals acquired by the output signal acquiring unit meet predetermined conditions, the output signals are in an initial state; and
a state transition acquiring unit for acquiring, as a state transition of the output signal, a set of the output signals acquired during a period from an acquisition of the output signal that is not in the initial state to immediately before an acquisition of the output signal that is in the initial state,
wherein, when the state transition acquired by the state transition acquiring unit is not stored in the state transition storing unit, the state transition adding unit adds and stores the state transition to/in the state transition storing unit.

16. An observation method of receiving a signal which is outputted by a unit to be observed, and for observing an operation of the unit to be observed, comprising the steps of:
acquiring an output signal which is outputted by the unit to be observed;
storing a set, which consists of parts of an output signal which correspond respectively to a sequence of two or more cycles, as a state transition of the output signal, if the output signal is acquired through the series of two and more cycles;
causing the state transition storing unit to additionally store a set of partial signal outputs corresponding a sequence of two or more cycles of the output signal which has been newly acquired by the output signal acquiring unit, as a new state transition, in a case where a state transition corresponding to the set concerning the newly acquired output signal has not been stored in the state transition storing unit; and
outputting a state transition of output signals which have been stored in the state transition storing step.

17. A program of an observation device for receiving a signal which is outputted from a unit to be observed, and for observing an operation of the unit to be observed, causing the observation device to function as:
an output signal acquiring unit for acquiring an output signal which is outputted by the unit to be observed;
a state transition storing unit for storing a set of partial signal outputs corresponding to a sequence of two or more cycles, as a state transition of the output signal, if the output signal is acquired through the sequence of two and more cycles;
a state transition adding unit for causing the state transition storing unit to additionally store a set of partial signal outputs corresponding to a sequence of two or more cycles of the output signal which has been newly acquired by the output signal acquiring unit, as a new state transition, in a case where a state transition corresponding to the set concerning the newly acquired output signal has not been stored in the state transition storing unit; and
a state transition outputting unit for outputting a state transition of output signals which have been stored in the state transition storing unit.
